(19) United States
(12) Patent Application Publication
(10) Pub. No.: US 2015/0360448 A1
(43) Pub. Date: Dec. 17, 2015

(54) WHITE VENEER COLORED PLASTIC SHEET

(71) Applicant: Klockner Pentaplast of America, Inc., Gordonsville, VA (US)

(72) Inventors: William J CRAWFORD, Springboro, OH (US); Carrie NAPPER, Gordonsville, VA (US); Timothy WEATHERILL, Gordonsville, VA (US); Thomas MUCENSKI, Gordonsville, VA (US); Andrew S. CAMPOS, Montgomery, IL (US)

(73) Assignee: Klockner Pentaplast of America, Inc., Gordonsville, VA (US)

(21) Appl. No.: 14/735,792

(22) Filed: Jun. 10, 2015

Related U.S. Application Data
(60) Provisional application No. 62/011,376, filed on Jun. 12, 2014.

(51) Int. Cl. B32B 27/08; B32B 37/12; B32B 27/30; B32B 37/00; B32B 27/36; B32B 27/32

(52) U.S. Cl. CPC B32B 27/08; B32B 27/36; B32B 27/32; B32B 27/304; B32B 37/0038; B32B 37/1284; B32B 2250/24; B32B 2307/402

(57) ABSTRACT

A plastic sheet for printing e.g., credit cards, and a method for manufacturing the plastic sheet. The plastic sheet includes at least one white cap layer and at least one colored corestock. The white cap layer may include a thin printable plastic. The white cap layer may also include a gauge in the range of 12 to 127 microns (0.0005 to 0.005 inch) thick, preferably 25 to 76 microns (0.001 to 0.003 inch), and most preferably 25 to 50 microns (0.001 to 0.002 inch). The white cap layer may further include a plastic material e.g., polyester (PET), polypropylene (PP), poly vinyl chloride (PVC), polystyrene (PS), poly lactic acid (PLA), or the like. Preferably, the white cap layer may include PET or PVC. Most preferably, a matte PVC may be used as the white cap layer in order to achieve excellent ink receptibility in printing.

### CROSS REFERENCE TO PRIOR APPLICATION

This application claims priority to and the benefit thereof from U.S. provisional patent application No. 62/011,376, filed Jun. 12, 2014, titled “White Veneer Colored Plastic Sheet,” the entirety of which is hereby incorporated herein by reference.

### FIELD OF DISCLOSURE

The present disclosure relates generally to a multilayer sheet product and a process for manufacturing the product.

### BACKGROUND OF THE DISCLOSURE

Printers of plastic cards such as, for example, credit cards and the like, from time to time print on solid color base film (corestock) so that a finished card that is die cut and punched from this material will show that same core color on the edge of the plastic card. The exposed base plastic (corestock) having a different color from the surface printing inks is considered a cosmetic advantage and selling point that is often desired by plastic card manufacturers.

Plastic card manufacturers often prefer to print surface inks on a white surface. This is due to the fact that surface printing inks are somewhat translucent and when printed on a white surface will reflect the desired coloration when viewed from above. For this reason, printers of plastic cards require a base surface of a white over their colored corestock to achieve a desired look of the artwork.

There exists an unfulfilled need for an inexpensively manufactured base colored corestock with an outer surface that is able to facilitate best practice printing.

### SUMMARY OF THE DISCLOSURE

According to an aspect of this disclosure, a multilayer sheet is provided that comprises a colored corestock layer and a white cap layer. The multilayer sheet may include an adhesive or bonding layer. The adhesive may include a thermo-reactive adhesive. The white cap layer may be dry bonded to the colored corestock layer. The multilayer sheet may be used in printing applications such as, e.g., printing credit cards, gift cards, store cards, signs, and the like.

According to another aspect of the disclosure, a method for manufacturing the multilayer sheet is provided. The method includes: receiving a first sheet of one of a colored corestock; receiving a second sheet of a white cap layer film; receiving an adhesive; applying the adhesive to a surface of the first sheet; and affixing a surface of the second sheet to the adhesive. The first and second sheets may be provided as rolls and the multilayer sheet may be manufactured using a roll-to-roll coating and lamination method or a roll-to-sheet coating and lamination method and then subsequently sheeted to size.

The method may include lamination, an extrusion, and/or calendered plastic that may be used to extrude at least one of the first and second sheets. The extrusion and/or calendered process may include, for example, blown film extrusion, sheet/film extrusion, tubing extrusion, overjacking extrusion, coextrusion, extrusion coating, film casting, calendering, and the like.

The white cap layer may include a material having a gauge or thickness in the range of about 12 to about 127 microns (about 0.0005 to about 0.005 inches), preferably about 25 to about 76 microns (about 0.001 to about 0.003 inch), and most preferably about 25 to about 50 microns (about 0.001 to about 0.002 inches).

The white cap layer may include a material that may be useful in the making of plastic cards. The white cap layer may include, e.g., polyester (PET), polypropylene (PP), poly vinyl chloride (PVC), polystyrene (PS), poly lactic acid (PLA), or the like, or a combination of the foregoing. Preferably, the white cap layer includes PET or PVC as these are materials commonly found in card manufacture. More preferably, the white cap layer includes a matte PVC, which may provide excellent ink receptibility in printing.

Alternatively (or additionally), the white cap layer may include a material that can alternatively be a blend of the polymers such as, for example, PET, PP, PVC, PS, PLA, or the like. The white cap layer may further include a recycled content of about 1 to about 85% of polymers without detracting from the performance of the product.

The colored corestock may include a colored polymer such as, for example, polyester (PET), polypropylene (PP), poly vinyl chloride (PVC), polystyrene (PS), poly lactic acid (PLA), or the like. The color of the corestock may be preselected by the manufacturer in accordance with their preference. The color of the corestock may be white. The corestock may further include a recycled content of about 1 to about 100% of polymers without detracting from the performance of the product.

The multilayer sheet may include an adhesive (or bonding agent) layer that binds the colored corestock to the white cap layer. The adhesive layer may (or may not) impart additional opacity or hiding power to the white cap layer. The adhesive layer may be formulated with polymeric compounds such as, for example, latex, acrylic, vinyl, urethane, natural rubber, synthetic rubber, or the like, as a base such that the properties and characteristics described in this disclosure are achieved.

The multilayer sheet may be compounded with pigment to obtain some level of opacity as measured with e.g., a transmission densitometer.

According to a further aspect of the disclosure, the opacity of the adhesive layer can be increased (or decreased) by adding (or removing) one or a combination of the common white pigments including but not limited to, e.g., the following: TiO2, CaCO3, Talc, BaSO4, ZnO, Al(OH)3. In an embodiment of the disclosure, the adhesive may be formulated with TiO2 in a loading of about 5% to about 70% versus dry solids. In a preferred embodiment of the disclosure, the loading of TiO2 may be from about 15% to about 30% versus dry solid composition of the adhesive. An advantage an opaque adhesive may confer is that it may optimally block darkly colored and black corestock.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a multilayer sheet, constructed according to the principles of the disclosure.

FIG. 2 shows an example of a method for manufacturing the multilayer sheet, according to the principles of the disclosure.

The present disclosure is further described in the detailed description that follows.

### DETAILED DESCRIPTION OF THE DRAWINGS

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single layer or article is described herein, it will be readily apparent that more than one layer or article may be used in place of a single layer or article. The functionality or the features of a layer or article may be alternatively embodied by one or more other layers or articles which are not explicitly described as having such functionality or features.

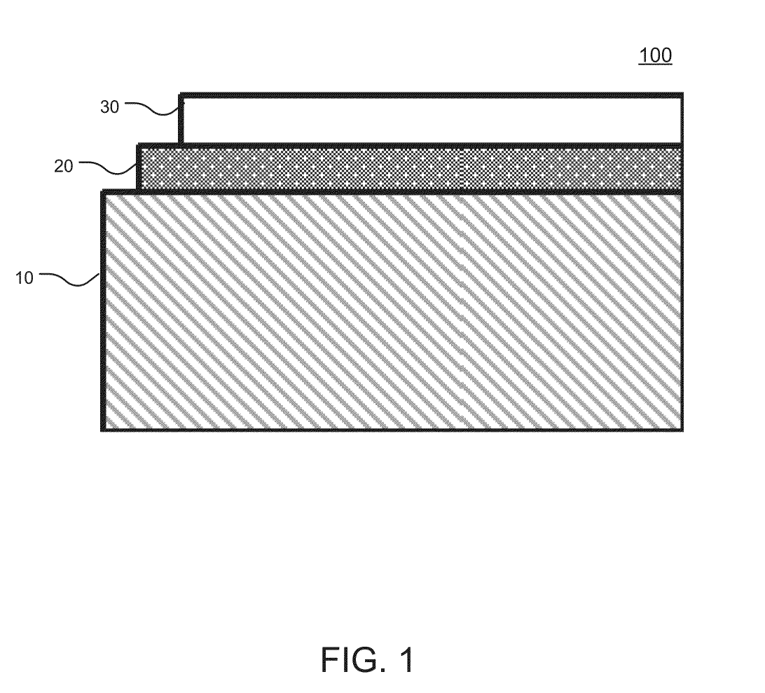

FIG. 1 shows an example of a multilayer sheet, according to the principles of the disclosure. The multilayer sheet 100 includes at least one colored corestock layer 10 and at least one white cap layer 30. The multilayer sheet 100 may include at least one adhesive layer 20. The white cap layer 30 may include a thin printable plastic. The white cap layer 30 may also include a gauge in the range of about 12 to about 127 microns (about 0.0005 to about 0.005inches) thick, preferably about 25 to about 76 microns (about 0.001 to about 0.003 inches), and most preferably about 25 to about 50 microns (about 0.001 to about 0.002 inch).

The white cap layer 30 may include, e.g., plastic polymers, useful in the making of plastic cards, such as, e.g., polyester (PET), polypropylene (PP), poly vinyl chloride (PVC), polystyrene (PS), poly lactic acid (PLA), or the like. Alternatively (or additionally), the white cap layer 30 may include a material that can be a blend of the plastic polymers. The white cap layer 30 may further include a recycled content of about 1 to about 85% of polymers without detracting from the performance of the product.

Preferably, the white cap layer 30 may include PET or PVC as these are materials commonly found in card manufacture. Most preferably, a matte PVC may be used as the white cap layer in order to achieve excellent ink receptibility in printing can be achieved.

The colored corestock layer 10 may include a colored polymer such as, for example, PET, PP, PVC, PS, PLA, or the like. The color of the corestock may be preselected by the manufacturer in accordance with their preference. The color of the corestock may be white. The corestock may further include a recycled content of about 1 to about 100% of polymers without detracting from the performance of the product.

The adhesive layer 20 may further include e.g., an adhesive, a bonding agent, and the like. The adhesive layer 20 may result in a bond greater than about 6N/cm between the white cap layer 30 and the colored corestock 10, when bond tests are performed using 90 Degree Peel Test ISO 10373/5.6. The adhesive layer 20 may hold the white cap layer 30 and the corestock layer 10 together so that a bond is formed greater than the plastic card requirements in standard ISO 7810. This will allow for normal card manufacturing practices such as die cutting without tooling residue or wear, product strength, durability, flexibility, and further add to the overall hiding power of the white cap layer.

The opacity of the adhesive layer can be increased by adding one or a combination of the common white pigments including but not limited to the following: TiO2, CaCO3, Talc, BaSO4, ZnO, Al(OH)3. In a preferred embodiment of the invention the adhesive is formulated with TiO2 in a loading of about 5% to about 70% vs dry solids. The most preferred loading of TiO2 is from about 15% to about 30% vs. dry solid composition of the adhesive. The advantage an opaque adhesive is to optimally block darkly colored and black corestock.

The adhesive layer 20 and the cap layer 30 may be compounded with pigment to obtain some level of opacity as measured with e.g., a transmission densitometer.

The multilayer sheet 100 may be considered a veneer product. The veneer product will be able to process on existing end user equipment similar to that used for the standard PVC sheet. The veneer product will print, laminate, collate, punch, and bond similar to existing PVC sheets that are common to the industry. The veneer product of the instant disclosure will render the print surface of the colored sheet to a standard white color with a tolerance of +/−2.5 Delta E (CIE LAB 1994).

The veneer product may provide a pure white surface as defined with colorimetry measured with a spectrophotometer. Providing a white color most close in color to a standard white print stock would be preferred. The white cap layer 30 would perform this function regardless of the color of the underlying colored corestock 10. The performance of the veneer product, including the white cap layer 30, may be measured as the perceptible color difference of the multilayer sheet 100 discussed herein in comparison to a specimen of a single sheet of standard white plastic. The color readings of these two materials may be compared and expressed mathematically as a CIE Lab Delta E value. The preferred Delta E value of the product discussed herein would have a value smaller than 4.0 Delta E. A most preferable value would be less than 2.5 Delta E. The veneer product will be able to process on existing user equipment similar to that used for the standard PVC sheet. The veneer product will print, laminate, collate, punch, and bond similar to existing PVC sheets common in the industry.

The hiding power (or opacity) of each layer (e.g., a colored corestock layer, a white cap layer, the adhesive layer, or the like) in the veneer product may be measured with many means such as, for example, transmission densitometry. The minimum value that is desirable for each layer individually is about 0.20 O.D. (optical density) as measured by an X-Rite C330 transmission densitometer or similar equipment. The preferable measured minimum value is about 0.40 O.D. And the most preferable minimum value for an opaque layer is about 0.50 O.D.

According to an aspect of the disclosure, a method for manufacturing the multilayer sheet is provided. The method includes receiving a first sheet of one of a colored corestock; receiving a second sheet of white cap layer film; receiving an adhesive; applying the adhesive to a surface of the first sheet; and affixing a surface of the second sheet to the adhesive. The first and second sheets may be provided as rolls and the multilayer sheet may be manufactured using a roll-to-roll coating and lamination method or a roll-to-sheet coating and lamination method and then subsequently sheeted to size.

The method may include lamination, an extrusion or calendered plastic that may be used to extrude at least one of the first and second sheets. The extrusion or calendered process may include, for example, blown film extrusion, sheet/film extrusion, tubing extrusion, overjacking extrusion, coextrusion, extrusion coating, film casting, calendering and the like. The lamination may include, e.g., a process as described in U.S. patent publication no. 2012/0132339 to Foley, SR et al.

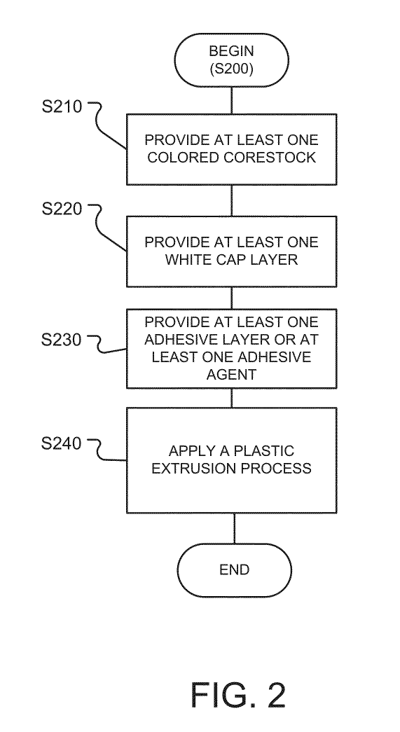

FIG. 2 shows an example of a method for producing a multilayer sheet in accordance with the principle of the disclosure. The method includes: providing at least one colored corestock (Step 210); providing at least one white cap layer (Step 220); applying a plastic extrusion (or lamination) process on the white cap layer and the colored corestock (Step 240). Alternatively, (or additionally) the method may include providing at least one adhesive layer between the colored corestock and the white cap layer prior to applying the plastic extrusion process (Step 230).

The adhesive (or bonding agent) layer may include polymeric compounds such as, for example, latex, acrylic, vinyl, urethane, natural rubber, synthetic rubber, or the like, as a base. They may also include e.g., glue, solvent bond, chemical adhesive, or the like.

The adhesive (or bonding agent) layer may result in a bond greater than about 6N/cm between the white cap layer and the colored corestock, when bond tests are performed using 90 Degree Peel Test ISO 10373/5.6.

The white cap layer and the colored corestock layer may include a material such as, for example, PET, PP, PVC, PS, PLA, or the like.

The plastic extrusion process (Step 240) may include a plastic extrusion process such as, for example, blown film extrusion, sheet/film extrusion, tubing extrusion, overjacking extrusion, coextrusion, extrusion coating, film casting, calendering and the like. The extrusion process may include e.g., using a roll for roll coating and lamination method or a roll to sheet coating and lamination method and then subsequently sheeted to size. An example of mechanical equipment that can be used to perform lamination in accordance with the principles of this disclosure is described in, e.g., U.S. Patent Application No. 2012/0132339 to Foley, SR et al.

The method as described in FIG. 2 may be automated to be carried out by a machine. In an aspect of the present disclosure, a computer readable storage medium tangibly embodying a computer readable program code having computer readable instructions which, when implemented, cause a machine to carry out the steps of a method for manufacturing the multilayer sheet includes: receiving a first sheet of one of a colored corestock; receiving a second sheet of a white cap layer film; receiving an adhesive; applying the adhesive to a surface of the first sheet; and affixing a surface of the second sheet to the adhesive. The machine may include a computer.

The process for manufacturing the plastic sheet may be considered a veneer process. The veneer process is an improvement over standard methods currently used in producing a plastic sheet to be used in e.g., printing plastic cards. Current method involve printing white base inks over corestock. Alternative method involves the time consuming and costly application of several white base coats of liquid ink via screen printing. Screen printing white ink can degrade the physical integrity of the finished cards. The veneer process obviates the additional printing steps and produces cards with excellent physical properties.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed is:

1. A multilayer sheet, comprising:
a colored corestock layer; and
a white cap layer which comprises at least one of: polyester (PET), polypropylene (PP), poly vinyl chloride (PVC), polystyrene (PS), and poly lactic acid (PLA).

2. The sheet according to claim 1, wherein the white cap layer comprises a gauge or thickness in the range of about 12 to about 127 microns.

3. The sheet according to claim 1, wherein the white cap layer comprises a recycled content of about 1 to about 85% of polymers.

4. The sheet according to claim 1, wherein the colored corestock layer comprises a colored polymer selected from at least one of: polyester (PET), polypropylene (PP), poly vinyl chloride (PVC), polystyrene (PS), and poly lactic acid (PLA).

5. The sheet according to claim 1, further comprising an adhesive layer which is configured to be placed between the colored corestock layer and the white cap layer.

6. The sheet according to claim 1, wherein colored corestock layer and the white cap layer are bonded to 6N/cm between the layers.

7. The sheet according to claim 1, wherein the sheet renders a print surface of a colored sheet to a standard white color with a tolerance of +/−2.5 Delta E.

8. The sheet according to claim 1, wherein the perceptible color difference of the multilayer sheet has a value in the range of about 0 to about 4.0 Delta E.

9. The sheet according to claim 8, wherein the color difference value is less than about 4.0 Delta E.

10. The sheet according to claim 1, wherein the sheet has an optical density value of about 0.20 O.D. to about 0.50 O.D.

11. The sheet according to claim 10, wherein the optical density is one of 0.2, 0.4 or 0.5 O.D.

12. The sheet according to claim 5, wherein the opacity of the adhesive layer is adjusted by adjusting the concentration of a white pigment selected from at least one of the following: TiO2, CaCO3, Talc, BaSO4, ZnO, and Al(OH)3.

13. The sheet according to claim 12, wherein the white pigment comprises TiO2 in a loading of about 5% to about 70% vs. dry solids.

14. The sheet according to claim 12, wherein the white pigment comprises TiO2 in a loading of about 15% to about 30% vs. dry solid.

15. The sheet according to claim 1, wherein the colored corestock comprises a recycled content of about 1 to about 100% of polymers.

16. A method of making the multilayer sheet comprising:
receiving a first sheet of one of a colored corestock layer;
receiving a second sheet of a white cap layer film; and
applying a plastic extrusion process,
wherein the white cap layer comprises at least one of: polyester (PET), polypropylene (PP), poly vinyl chloride (PVC), poly styrene (PS), and polylactic acid (PLA).

17. The method according to claim 16 further comprising: providing at least one adhesive layer between the colored corestock and the white cap layer prior to applying the plastic extrusion process

18. The method according to claim 16 further comprising: applying a roll-to-roll coating and lamination process.

19. A computer readable storage medium tangibly embodying a computer readable program code having computer readable instructions which, when implemented, cause a machine to carry out the steps of a method for manufacturing the multilayer sheet comprising:
receiving a first sheet of one of a colored corestock;
receiving a second sheet of a white cap layer film;
receiving an adhesive;
applying the adhesive to a surface of the first sheet; and
affixing a surface of the second sheet to the adhesive,
wherein the adhesive is configured to be placed between the first sheet and the second sheet.

20. The method according to claim 19 wherein the white cap layer comprises at least one of: polyester (PET), polypropylene (PP), poly vinyl chloride (PVC), poly styrene (PS), and polylactic acid (PLA).
